(19) United States
(12) Patent Application Publication
(10) Pub. No.: US 2014/0111084 A1
(43) Pub. Date: Apr. 24, 2014

(54) OLED LIGHTING DEVICE

(71) Applicant: Ultimate Image Corporation, Miaoli County (TW)

(72) Inventor: Chih-Feng SUNG, Miaoli County (TW)

(73) Assignee: Ultimate Image Corporation, Miaoli County (TW)

(21) Appl. No.: 14/051,602

(22) Filed: Oct. 11, 2013

(30) Foreign Application Priority Data
Oct. 19, 2012 (TW) 101138817

(51) Int. Cl. H05B 33/08

(52) U.S. Cl. CPC H05B 33/0896
USPC 313/512

(57) ABSTRACT

An organic light-emitting diode (OLED) lighting device comprises an organic light emitting unit and a power supply unit. The organic light emitting unit has a substrate, and a first electrode layer, an organic light emitting layer and a second electrode layer sequentially laminated on the substrate. The first electrode layer and the second electrode layer have a first contact portion and a second contact portion extending toward the periphery of the substrate, respectively. The power supply unit has a plurality of power supply elements. Each power supply element has a conductive terminal portion and an insulating portion. Each conductive terminal portion has an inner surface and an outer surface opposite to the inner surface. The inner surfaces are correspondingly connected to and completely cover the first contact portion and the second contact portion, respectively. Each insulating portion completely covers the outer surface of each conductive terminal portion.

### FIELD OF THE INVENTION

The invention relates to a lighting device, and more particularly to an organic light-emitting diode lighting device.

### BACKGROUND OF THE INVENTION

Organic light-emitting diodes (OLEDs) have attracted extensive attention in display and lighting applications since they have several advantages such as self-luminous, low power source consumption and fast response time. OLED electrically excites a light-emitting layer of a fluorescent or phosphorescent organic compound to emit light.

A conventional OLED lighting device is disclosed in U.S. Pat. No. 6,936,964 or U.S. Pat. No. 8,154,200, in which a cap is fixed to a substrate so as to protect the OLED element on the substrate by the cap and the substrate. Moreover, electrodes of the OLED element have contact portions extending to outside of the cap, for electrically connecting with an external power source, so that the OLED element is driven to emit light.

FIG. 1 is a sectional schematic diagram showing a conventional OLED lighting device 10. On a substrate 11, an anode electrode 12, an organic light emitting layer 13 and a cathode electrode 14 are formed sequentially. A cap 15 is fixed on the substrate 11 by a sealant 16. The anode electrode 12 has a contact portion 121, and the cathode electrode 14 has a contact portion 141. The contact portions 121, 141 extend from the surface of the substrate 11 to outside of the cap 15, for electrically connecting with clamps 17 of an external power source. FIG. 2 is a top view schematic diagram showing the OLED lighting device shown in FIG. 1. These contact portions 121, 141 are disposed on the periphery of the substrate 11 in intervals, for electrically connecting with the clamps 17 of the external power source, respectively.

However, since the clamps 17 of the external power source do not completely cover the contact portions 121,141, the contact portions 121, 141 are exposed partially and thus they are easily contacted by other conductive object inadvertently. This leads to a short-circuit problem by conduction of the contact portions 121, 141. Moreover, since the clamps 17 themselves have conductive properties, they also have the risk of causing short-circuit.

### SUMMARY OF THE INVENTION

One object of the invention is to provide an organic light-emitting diode (OLED) lighting device, so as to solve the short-circuit problem of the conventional OLED lighting device.

The invention provides an OLED lighting device, including an organic light emitting unit and a power supply unit. The organic light emitting unit has a substrate, and a first electrode layer, an organic light emitting layer and a second electrode layer are sequentially laminated on the substrate. The first electrode layer and second electrode layer have a first contact portion and a second contact portion extending toward the periphery of the substrate, respectively. The power supply unit has a plurality of power supply elements. Each power supply element includes a conductive terminal portion and an insulating portion. Each conductive terminal portion has an inner surface and an outer surface opposite to the inner surface. These inner surfaces are correspondingly connected to and completely cover the first contact portion and the second contact portion, respectively, and each insulating portion completely covers the outer surface of each conductive terminal portion.

In an embodiment of the invention, the above-mentioned substrate is a transparent substrate.

In an embodiment of the invention, the above-mentioned organic light emitting unit further includes a protection layer disposed above the organic light emitting layer.

In an embodiment of the invention, the above-mentioned protection layer is fixed on the substrate by a sealant.

In an embodiment of the invention, each of the above-mentioned power supply element is a conductive clamp element clamped on the periphery of the substrate, each conductive clamp element includes a metallic clamp arm as the conductive terminal portion and an insulation cover as the insulating portion for covering the metallic clamp arm.

In an embodiment of the invention, the above-mentioned power supply unit further has a circuit board, and an end of each power supply element is fixed on the circuit board.

In an embodiment of the invention, the shape of the above-mentioned substrate is rectangular, the number of the first contact portions is four, which are disposed at four sides of the rectangular substrate, respectively, and the number of the second contact portions is four, which are disposed at four sides of the rectangular substrate, respectively.

In an embodiment of the invention, the above-mentioned power supply unit is a flexible circuit board, the flexible circuit board has a plurality of branch portions as the power supply elements, and each branch portion includes a conductive wire as the conductive terminal portion and an insulating layer as the insulating portion for covering the conductive wire.

In an embodiment of the invention, the above-mentioned power supply unit is a probe unit, the probe unit has probe elements as the power supply elements, each probe element has a probe as the conductive terminal portion and an insulation case as the insulating portion for covering the probe

According to the invention, the upper surfaces of the first contact portion and the second contact portion are completely covered by the conductive terminal portions of the power supply elements, and the conductive terminal portions are completely covered by the insulating portions. In this way, the first contact portion, the second contact portion and the conductive terminal portions would not be easily contacted by other conductive object inadvertently and cause a short-circuit problem.

### BRIEF DESCRIPTION OF THE DRAWINGS

The invention will become more readily apparent to those ordinarily skilled in the art after reviewing the following detailed description and accompanying drawings, in which:

FIG. 1 is a sectional schematic diagram showing a conventional organic light-emitting diode (OLED) lighting device.

FIG. 2 is a top view schematic diagram showing the OLED lighting device shown in FIG. 1

FIG. 3 is a sectional schematic diagram showing an OLED lighting device according to a first embodiment of the invention.

FIG. 4 is a top view schematic diagram showing the OLED lighting device according to the first embodiment of the invention.

FIG. 5 is a sectional schematic diagram showing the OLED lighting device along line A-A shown in FIG. 4.

FIG. 6 is a sectional schematic diagram showing an OLED lighting device according to a second embodiment of the invention.

FIG. 7 is a sectional schematic diagram showing an OLED lighting device according to a third embodiment of the invention.

FIG. 8 is a partial top view schematic diagram showing the OLED lighting device according to the third embodiment of the invention.

FIG. 9 is a sectional schematic diagram showing an OLED lighting device according to a fourth embodiment of the invention.

FIG. 10 is a partial top view schematic diagram showing the OLED lighting device according to the fourth embodiment of the invention.

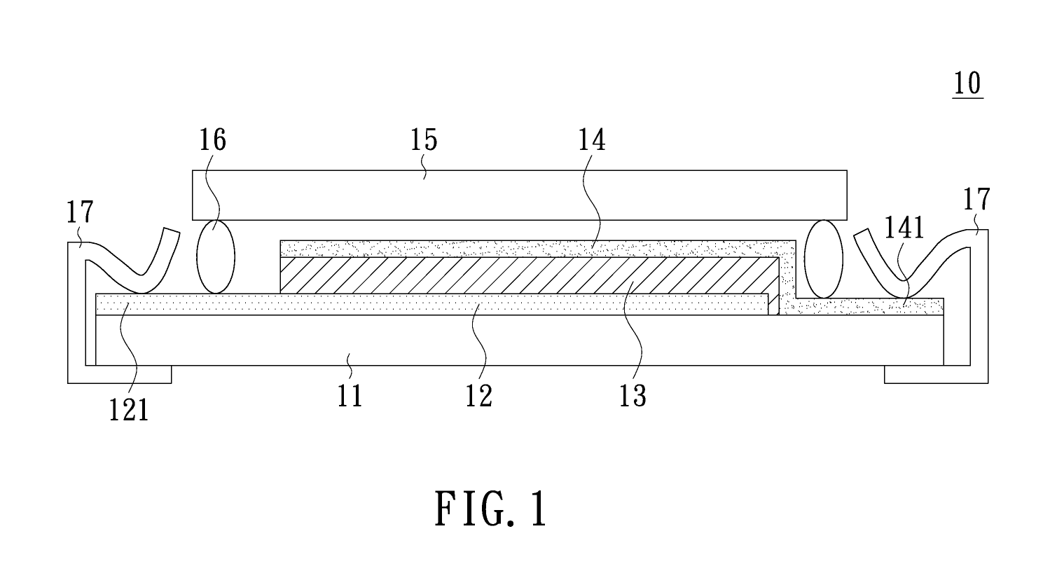

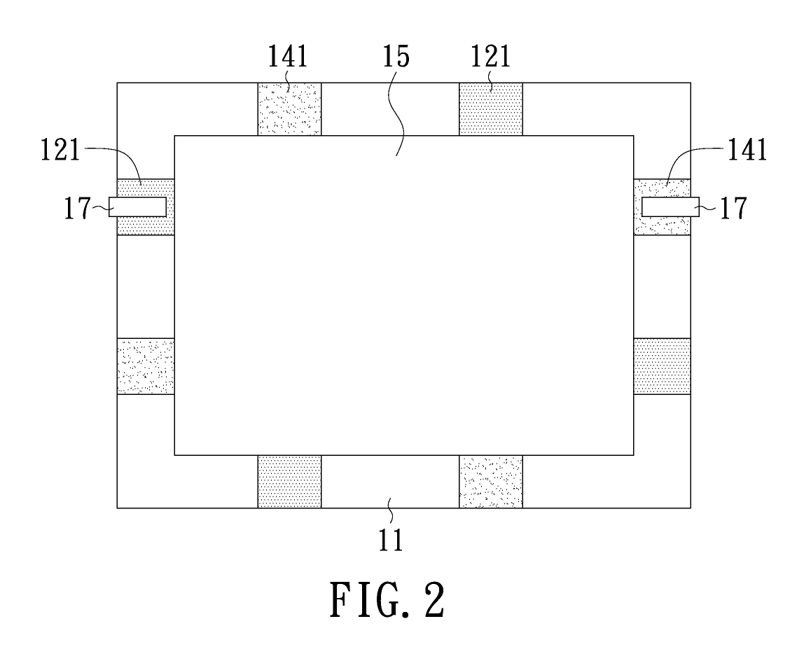

### DETAILED DESCRIPTION OF PREFERRED EMBODIMENTS

The invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

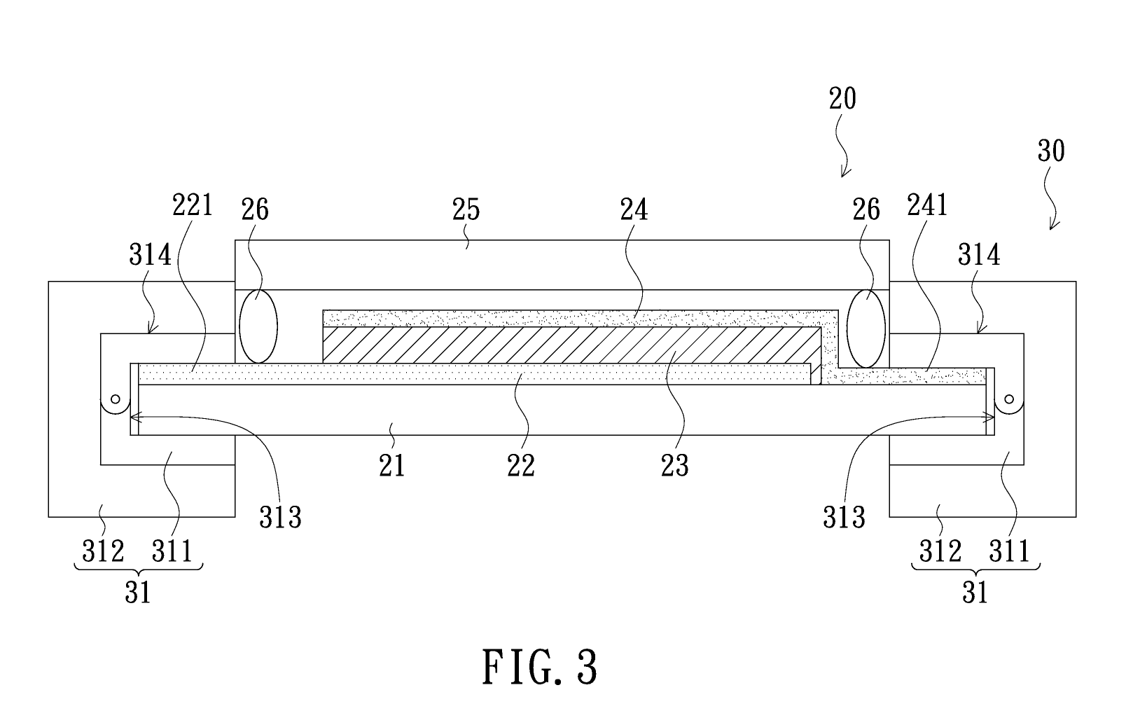

FIG. 3 is a sectional schematic diagram showing an organic light emitting diode (OLED) lighting device according to a first embodiment of the invention. As shown in FIG. 3, the OLED lighting device mainly includes an organic light emitting unit 20 and a power supply unit 30.

The organic light emitting unit 20 has a substrate 21, and a first electrode layer 22, an organic light emitting layer 23 and a second electrode layer 24 are sequentially disposed on the substrate 21. The substrate 21 may be, but not limited to, a transparent substrate in a rectangular shape. The organic light emitting layer 23 may include, for example, an electron transport layer, an electroluminescent layer and a hole transport layer deposited sequentially. The first electrode layer 22 is made of, for example, a transparent conductive film that is at least partially transparent. The second electrode layer 24 is made of, for example, an opaque metallic thin film.

The first electrode layer 22 has at least a first contact portion 221 extending toward the periphery of the substrate 21, and the second electrode layer 24 has at least a second contact portion 241 extending toward the periphery of the substrate 21.

Moreover, the organic light emitting unit 20 further includes, for example, a protection layer 25 disposed above the organic light emitting layer 23. The protection layer 25 is, for example, a cap made of glass, a plastic material or other insulating material. The protection layer 25 is, for example, fixed on the substrate 21 by a sealant 26, in a manner that the first contact portion 221 and the second contact portion 241 are exposed to outside of the protection layer 25. Moreover, alternative to the practice of a protection layer with a sealant, the protection layer 25 may be, for example, a multi-layer light-transmissive thin film stacked on the substrate 21 to cover the organic light emitting layer 23.

The power supply unit 30 has a plurality of power supply elements 31 corresponding to the first contact portion 221 and the second contact portion 241. In this embodiment, each power supply element 31 is, for example, a conductive clamp element which is fixed on the substrate 21 by clamping on the periphery of the substrate 21, and is electrically connected with the first contact portion 221 and the second contact portion 241. Each conductive clamp element includes a metallic clamp arm as a conductive terminal portion 311, and an insulation cover as an insulating portion 312 for covering the metallic clamp arm. Each conductive terminal portion 311 has an inner surface 313 and an outer surface 314 opposite to the inner surface 313. The insulating portion 312 completely covers the outer surface 314 of the conductive terminal portion 311.

When a voltage is applied, a current flows from the power supply element 31 at the left side of FIG. 3 to the first contact portion 221 of the first electrode layer 22, then to the second electrode layer 24 via the organic light-emitting layer 23, and to the power supply element 31 at the right side of FIG. 3 via the second contact portion 241 of the second electrode layer 24. Negatively charged electrons move from the second electrode layer 24 to the organic light-emitting layer 23, while positively charged holes move from the first electrode layer 22 to the organic light-emitting layer 23. When the negatively charged electrons and the positively charged holes meet in the organic light-emitting layer 23, they recombine and emit photons. The photons are emitted to the outside through the first electrode layer 22 and the substrate 21.

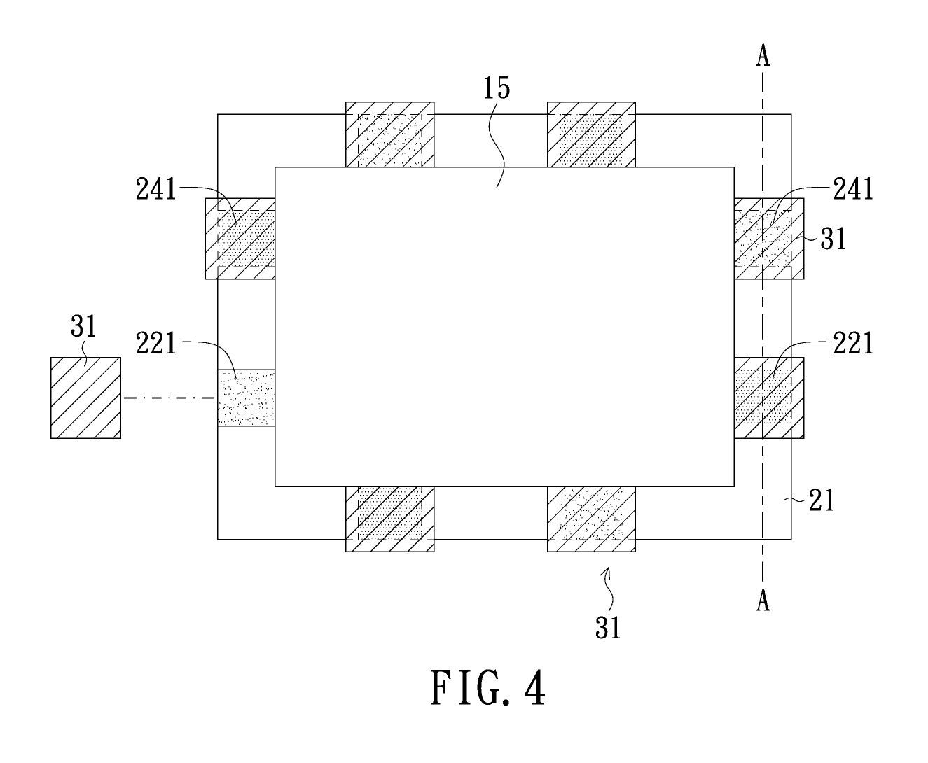

FIG. 4 is a top view schematic diagram showing the OLED lighting device according to the first embodiment of the invention. In this embodiment, for example, four first contact portions 221 are disposed at four sides of the rectangular substrate 21, respectively, and four second contact portions 241 are also disposed at four sides of the rectangular substrate 21, respectively. Each first contact portion 221 and each second contact portion 241 are disposed in intervals with each other. It should be noted that the numbers and disposed positions of the first contact portions 221 and the second contact portions 241 are not limited to what shown in FIG. 4. As shown in FIG. 4, the power supply unit 30 has a plurality of power supply elements 31 correspondingly electrically connected with the first contact portion 221 and the second contact portion 241 by clamping, respectively.

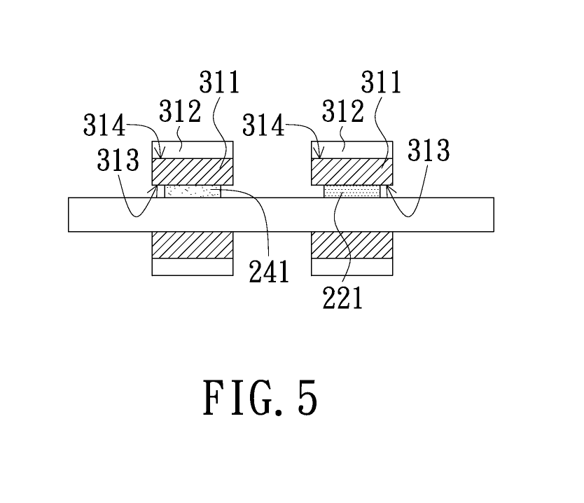

FIG. 5 is a sectional schematic diagram showing the OLED lighting device along line A-A shown in FIG. 4. As shown in FIG. 5, the inner surfaces 313 of the conductive terminal portions 311 not only are correspondingly connected to the first contact portion 221 and the second contact portion 241, respectively, but also completely cover the first contact portion 221 and the second contact portion 241.

The upper surfaces of the first contact portion 221 and the second contact portion 241 are completely covered by the conductive terminal portions 311, and the outer surfaces 314 of the conductive terminal portions 311 are completely covered by the insulating portions 312. Therefore, the first contact portion 221 and the second contact portion 241, or the conductive terminal portions 311 themselves would not be easily contacted by other conductive object inadvertently and cause a short-circuit problem.

Moreover, as shown in FIG. 5, even though the lateral surfaces of the first contact portion 221 and the second contact portion 241 are not completely covered by the power supply element 31, since the first contact portion 221 and the second contact portion 241 are actually thin films with thinner thicknesses, the opportunities for their lateral surfaces to inadvertently contact with conductive objects from the outside and cause a short-circuit problem are relatively low.

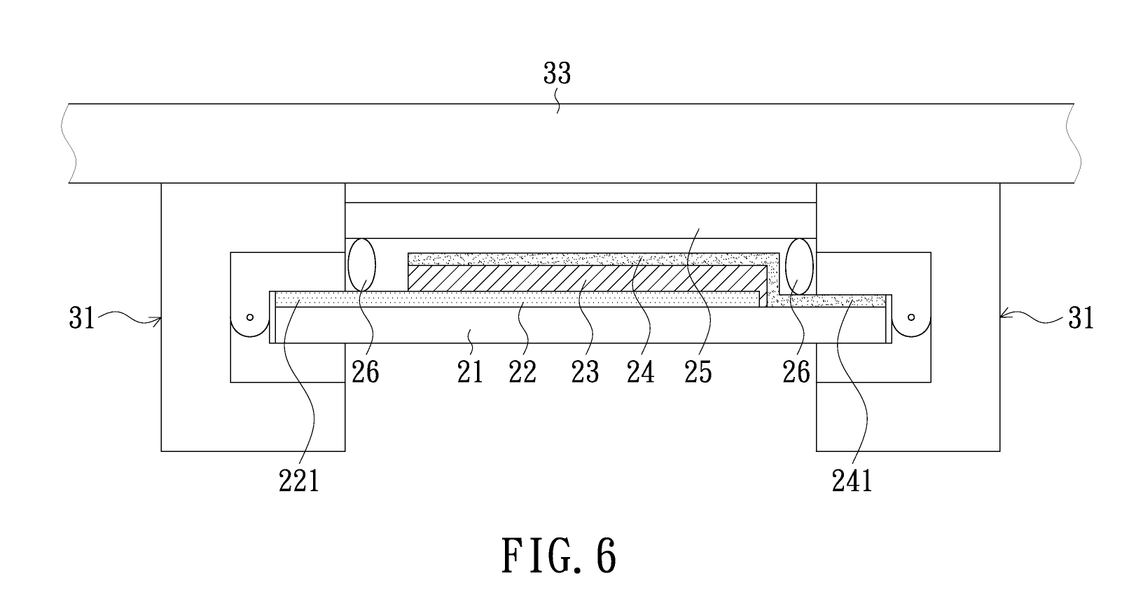

FIG. 6 is a sectional schematic diagram showing an OLED lighting device according to a second embodiment of the invention. The OLED lighting device shown in FIG. 6 is substantially the same as that of the first embodiment, except that the power supply unit 30 further includes a circuit board 33, and an end of each power supply element 31 is fixed on the circuit board 33. The circuit board 33 is electrically connected to an external power source, and the organic light emitting unit 20 is powered via each power supply element 31, so that the organic light emitting unit 20 is driven to emit light.

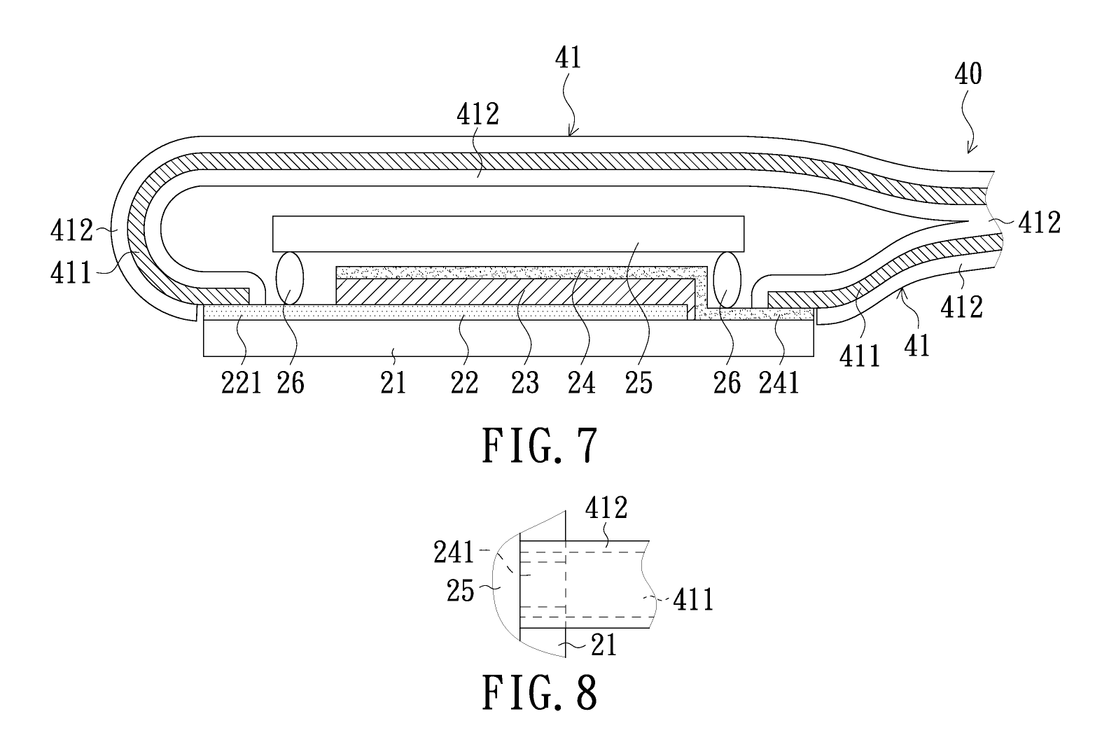

FIGS. 7 and 8 are a sectional schematic diagram and a partial top view schematic diagram showing an OLED lighting device according to a third embodiment of the invention, respectively. The OLED lighting device shown in FIG. 7 is substantially the same as that of the first embodiment, except that a power supply unit 40 is a flexible circuit board. The flexible circuit board 40 has a plurality of branch portions 41 as power supply elements. Each branch portion 41 includes a conductive wire 411 as a conductive terminal portion, and an insulating layer 412 as an insulating portion for covering the conductive wire 411.

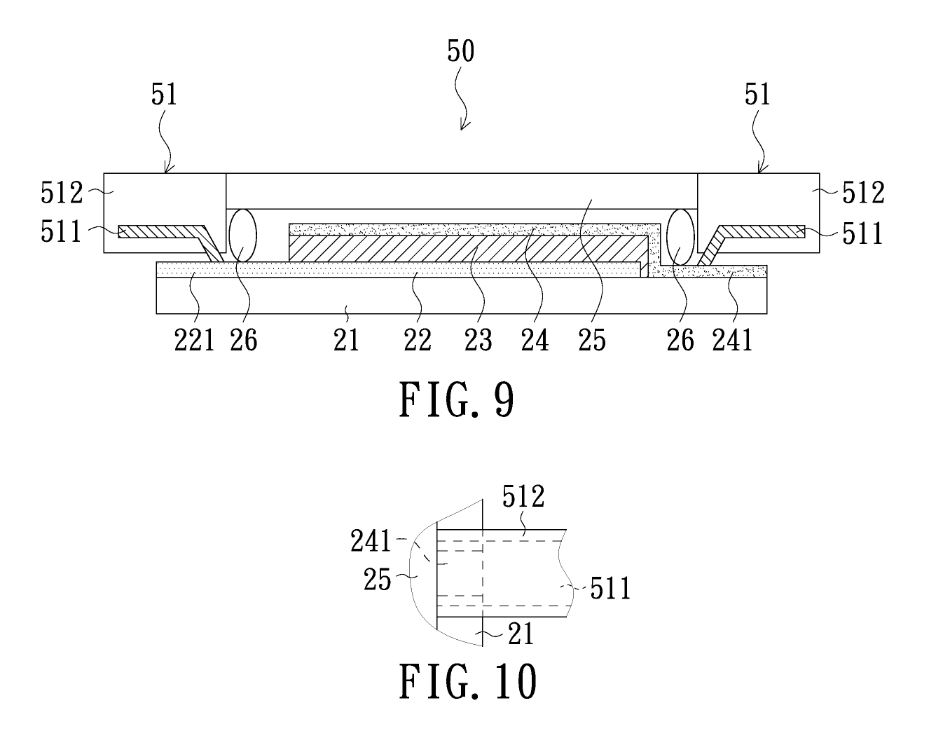

FIGS. 9 and 10 are a sectional schematic diagram and a partial top view schematic diagram showing an OLED lighting device according to a fourth embodiment of the invention. The OLED lighting device shown in FIG. 9 is substantially the same as that of the first embodiment, except that a power supply unit 50 is a probe unit. The probe unit 50 has a plurality of probe elements 51 as power supply elements. Each probe element 51 has a probe 511 as a conductive terminal portion, and an insulation case 512 as an insulating portion for covering the probe 511.

It should be noted that the power supply unit is not limited to the conductive clamp, the flexible circuit board, or the probe unit of the above-mentioned embodiments. Other power supply unit that completely covers the contact portion and has insulating material on its outer surface can also be used in practical implementation.

In summary, the invention has at least the following advantages:

The upper surfaces of the first contact portion and the second contact portion are completely covered by the conductive terminal portions of the power supply elements, and the conductive terminal portions are completely covered by the insulating portions. Therefore, the first contact portion, the second contact portion or the conductive terminal portions themselves would not be easily contacted by other conductive object inadvertently and cause a short-circuit problem.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An organic light-emitting diode (OLED) lighting device, comprising:
an organic light emitting unit having a substrate, and a first electrode layer, an organic light emitting layer and a second electrode layer sequentially laminated on the substrate, the first electrode layer and the second electrode layer having at least a first contact portion and at least a second contact portion extending toward the periphery of the substrate, respectively; and
a power supply unit having a plurality of power supply elements, each power supply element including a conductive terminal portion and an insulating portion, each conductive terminal portion having an inner surface and an outer surface opposite to the inner surface, these inner surfaces correspondingly connected to and completely covering the first contact portion and the second contact portion, respectively, each insulating portion completely covering the outer surface of each conductive terminal portion.

2. The OLED lighting device according to claim 1, wherein the substrate is a transparent substrate.

3. The OLED lighting device according to claim 1, wherein the organic light emitting unit further comprises a protection layer disposed above the organic light emitting layer.

4. The OLED lighting device according to claim 3, wherein the protection layer is fixed on the substrate by a sealant.

5. The OLED lighting device according to claim 1, wherein each power supply element is a conductive clamp element clamped on the periphery of the substrate, each conductive clamp element comprises a metallic clamp arm as the conductive terminal portion and an insulation cover as the insulating portion for covering the metallic clamp arm.

6. The OLED lighting device according to claim 5, wherein the power supply unit further comprises a circuit board, and an end of each power supply element is fixed on the circuit board.

7. The OLED lighting device according to claim 1, wherein the power supply unit is a flexible circuit board, the flexible circuit board has a plurality of branch portions as the power supply elements, each branch portion comprises a conductive wire as the conductive terminal portion and an insulating layer as the insulating portion for covering the conductive wire.

8. The OLED lighting device according to claim 1, wherein the power supply unit is a probe unit, the probe unit has a plurality of probe elements as the power supply elements, each probe element comprises a probe as the conductive terminal portion and an insulation case as the insulating portion for covering the probe.
